(19) United States
(12) Patent Application Publication
(10) Pub. No.: US 2026/0138360 A2
(43) Pub. Date: May 21, 2026

(54) MACHINE FOR CHECKING FLEXOGRAPHIC PRINTING PLATES, OR OFFSET PLATES, OR PRINTING PLATES ASSEMBLIES, OR PRINTED SURFACES

(71) Applicant: Bieffebi S.r.l., Granarolo dell’Emilia (Bologna) (IT)

(72) Inventor: Lorenzo Sambri, Granarolo dell’Emilia (Bologna) (IT)

(21) Appl. No.: 18/925,779

(22) Filed: Oct. 24, 2024

(30) Foreign Application Priority Data
Oct. 24, 2023 (IT) 102023000022305

(51) Int. Cl. B41F 33/00; B41F 5/24

(52) U.S. Cl. CPC B41F 33/0036; B41F 5/24

(57) ABSTRACT

A machine for checking flexographic printing plates, or offset plates, or plate assemblies, or printed surfaces, including a base, a support plane, associated with the base, for at least one printing plate, or offset plate, or plate assembly, or printed surface, the surface or physical characteristics of which are to be checked and controlled, a control unit, and a surface scanning unit of the at least one printing plate, or offset plate, or plate assembly, or printed surface to be checked. The scanning unit is operatively connected to the control unit, and is configured to acquire a real image of the at least one printing plate, or offset plate, or plate assembly, or printed surface to be checked.

### TECHNICAL FIELD OF THE INVENTION

The present invention relates to a machine for checking flexographic plates, or of offset plates, or printing plates assemblies, or printed surfaces.

More specifically, the present invention concerns a machine that allows for a preventive quality control of flexographic plates, or offset plates, or printing plates assemblies, or printed surfaces, so as to avoid the use of unsuitable plates and to avoid the creation of relative print tests or to speed up the initialization of new print jobs whilst, in all these circumstances, reducing energy consumption and therefore CO₂.

### BACKGROUND ART

In various printing sectors, and in particular in the flexographic printing sector, with reference, by way of example only, to some application areas such as box factories and the like, but not only, before carrying out a specific printing job, it is necessary to carry out expensive and laborious printing tests with inks to verify the quality of the plate used, and/or its correct positioning on the printing cylinder. Such tests can be quite time-consuming, and of course the printing press cannot start operating profitably until the quality and/or positioning checks have given the expected results.

The above tests can be carried out on specific dedicated machines, which have the function of allowing the execution of verification tests on the plates used in the printing job.

By using such testing machines, we avoid having to carry out tests directly on the printing machine, which would be extremely expensive and laborious.

The printing tests performed must then allow the operator to carry out a check, essentially of a visual nature, of the qualitative characteristics of the plate, in order to identify any defects or inaccuracies that could be the consequence of errors in the construction of the plate itself.

To be effective, carrying out these visual checks naturally requires a certain amount of time, and also the skill of an expert operator.

This verification time is inevitably added to the time needed to run the print tests on the dedicated machine.

Furthermore, no matter how quickly these operations can be carried out, there remains a certain margin of uncertainty due to the human factor, namely the visual control carried out by the operator.

Therefore, the need is felt to improve the state of the art in order to limit the time required for mounting unsuitable plates and the related printing tests, and also to be able to eliminate the uncertainties caused by possible errors committed by the operator in charge of quality checks.

In fact, in cases where a plate is found to be affected by errors or inaccuracies, the economic damage for the user can be considerable, especially because a lot of time is wasted in returning the defective plate to the manufacturer, and in producing a replacement with the related new delivery.

Similar considerations can be made for the field of offset printing, where the plates are absolutely not checked before use. This aspect can therefore lead to huge losses of material and money in the case of erroneous prints not previously checked.

It should also be noted that there are numerous printing machines in operation on the market, including rotogravure, which do not have any in-line control system for the printed film.

In order to initialize such printing machines, it is therefore necessary to consume several hundred meters before being able to verify with certainty the correctness of the printed material.

It is therefore necessary to create an automated offline system that allows for the automatic verification and validation of such situations in order to avoid numerous wastes.

### SUMMARY OF THE INVENTION

The technical aim of the present invention is therefore to improve the state of the art in the printing sector, in particular—but not only—flexographic printing sector. Within such technical aim, it is an object of the present invention to develop a machine for checking flexographic printing plates, or offset plates, or printing plate assemblies, or printed surfaces, which allows the previously mentioned drawbacks to be overcome automatically and without human discretion.

Another aim of the present invention is to make available a machine for checking flexographic printing plates, or offset plates, or printing plate assemblies, or printed surfaces, which allows qualitative checks to be carried out on a flexographic plate even when it has just been produced, and therefore upstream of any other test, or even on offset plates, or on plate assemblies, or on printed surfaces, just produced, or in order to speed up the initialization of new printing jobs on existing machines without control systems, in any case reducing energy consumption and therefore CO₂ in all these circumstances.

Another object of the present invention is to provide a machine for checking flexographic printing plates which allows the user to avoid the mounting of unsuitable plates and related printing tests to check the quality of a given plate.

A further object of the present invention is to provide a machine for checking flexographic printing plates, or offset plates, or printing plate assemblies, or printed surfaces, which is constructionally simple and economical.

Another object of the present invention is to devise a machine for checking flexographic printing plates, or offset plates, or printing plate assemblies, or printed surfaces, which is immediate, intuitive and versatile to use.

This aim and these objects are all achieved by the machine for checking flexographic printing plates, or offset plates, or printing plate assemblies, or printed surfaces, according to the present application.

The machine comprises a base, and a support plane, associated with the base, for at least one printing plate, or an offset plate, or a plate assembly, or a printed surface, the surface or physical characteristics of which must be automatically verified, validated and controlled.

The machine also comprises a control unit, and a scanning unit for the surface of the at least one printing plate or an offset plate, or a plate assembly, or a printed surface, to be checked.

The scanning unit is operationally connected to the control unit, and is configured to acquire a real image of the at least one printing plate, or the offset plate, or the plate assembly, or the printed surface, to be checked.

The control unit is configured to perform a comparison between the real image of the at least one printing plate, or the offset plate, or the plate assembly, or the printed surface, acquired by the scanning unit, and the reference image corresponding to the plate creation file, or to the file of a sheet comprising multiple plates, or the offset plate creation file, or the file of the final print to be produced. The present application refers to preferred and advantageous embodiments of the invention.

According to another aspect of the invention, the scanning unit comprises a carriage, and guide means, provided in the base, for the aforementioned carriage; the carriage is slidable, above the support plane, along a predetermined direction. The scanning unit further comprises at least one scanning sensor installed on the carriage; the scanning sensor is fixed below the lower surface, in use, of the carriage, so as to be positioned facing the support plane, and at a given distance from the upper surface of the at least one printing plate, or offset plate, or plate assembly, or printed surface, to be checked.

### BRIEF DESCRIPTION OF THE DRAWINGS

These and further advantages will be better understood by any person skilled in the art from the following description and the attached drawings, given as a non-limiting example, in which:

FIG. 1 is an axonometric view of the machine according to the invention;

FIG. 2 is a side view of the machine;

FIG. 3 is a front view of the machine;

FIG. 4 is a top view of the machine;

FIG. 5 is an isometric view of the machine with some parts removed;

FIG. 6 is an axonometric view of the machine with some parts removed, from a different angle;

FIG. 7 is a side view of the machine, with some parts removed;

FIG. 8 is a front view of the machine, with some parts removed;

FIG. 9 is a top view of the machine, with some parts removed;

FIG. 10 is a detail of FIG. 5;

FIG. 11 is a front view of the machine, according to another embodiment of the invention;

FIG. 12 is a top view of the machine according to the embodiment of FIG. 11;

FIG. 13 is a screenshot of the machine's user interface, showing the result of the image acquisition of a flexographic plate, carried out by the scanning unit;

FIG. 14 is a screenshot of the machine's user interface, showing the comparison between the cliché image in FIG. 13 and the respective reference image;

FIG. 15 is a screenshot of the machine's user interface, showing the automatic detection of defects that emerged from the comparison of FIG. 14;

FIG. 16 is a screenshot of the machine's user interface, showing the result of the image acquisition of another flexographic plate, performed by the scanning unit;

FIG. 17 is a screenshot of the machine's user interface, showing the comparison between the cliché image in FIG. 16 and the respective reference image;

FIG. 18 is a screenshot of the machine's user interface, showing the automatic detection of defects that emerged from the comparison of FIG. 17;

FIG. 19 is an enlargement of FIG. 18, corresponding to one of the defects detected;

FIG. 20 is a screenshot of the machine's user interface, showing the comparison between the image of a group of flexographic plates and their respective reference images, highlighting that the central plate of the group has been mounted by mistake;

FIG. 21 is a screenshot of the machine's user interface, showing the result of the image acquisition of a printed film, performed by the scanning unit;

FIG. 22 is a screen shot of the machine interface, which represents a zoom, or enlargement, of the screen in FIG. 21; and

FIG. 23 is a screen shot of the machine interface, which represents a zoom, or enlargement, of the screen in FIG. 22.

### DETAILED DESCRIPTION OF THE INVENTION

With reference to the attached figures, the numeral 1 generally indicates a machine for checking flexographic printing plates, or offset plates, or printing plate assemblies, or printed surfaces, according to the present invention.

The machine 1 comprises a base, indicated overall by 2.

The machine 1 also includes a support plane 3.

The support plane 3 is associated with the base 2, and it defines a support surface for at least one printing plate, or offset plate for offset printing, or plate mounting, or printed surface 4, whose surface or physical characteristics must be verified and controlled.

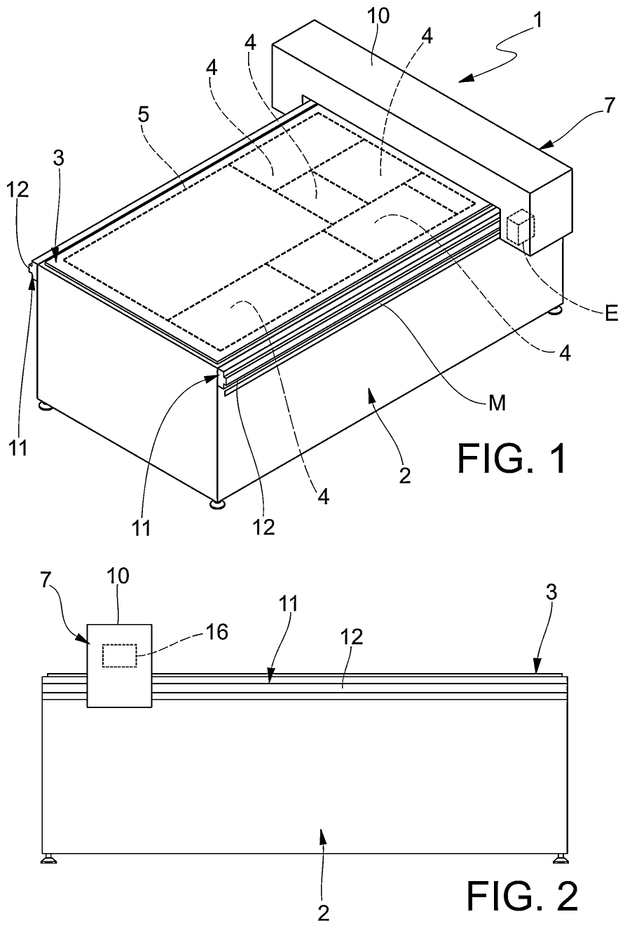

In more detail—and with reference to the schematic representation in FIG. 1—a single sheet 5 (typically made of photopolymer) can also be positioned on the support plane 3, from which different plates 4 will then be obtained, by cutting, or different offset plates, or different plate assemblies, or different printed surfaces.

In fact, in FIG. 1, the dotted lines represent—schematically and only for better understanding-the cutting lines through which different plates 4 (or offset plates, or plate assemblies, or printed surfaces) will be obtained starting from the single sheet 5.

This allows for the optimization of the production phase of the plates 4 (or offset plates, or plate assemblies, or printed surfaces), exploiting, as much as possible, the entire surface of the sheet 5, minimizing waste and scrap.

Alternatively, on the support plane 3 it is also possible to place-obviously-one or more plates 4, already made and finished (i.e., already cut), to be checked, or more offset plates, or more plate assemblies, or more printed surfaces.

It should be noted that the plates, or the plate assemblies 4, can be either new or used (and therefore possibly superficially worn to a certain extent).

Furthermore, printed surfaces can also be made of printed films (transparent or non-transparent).

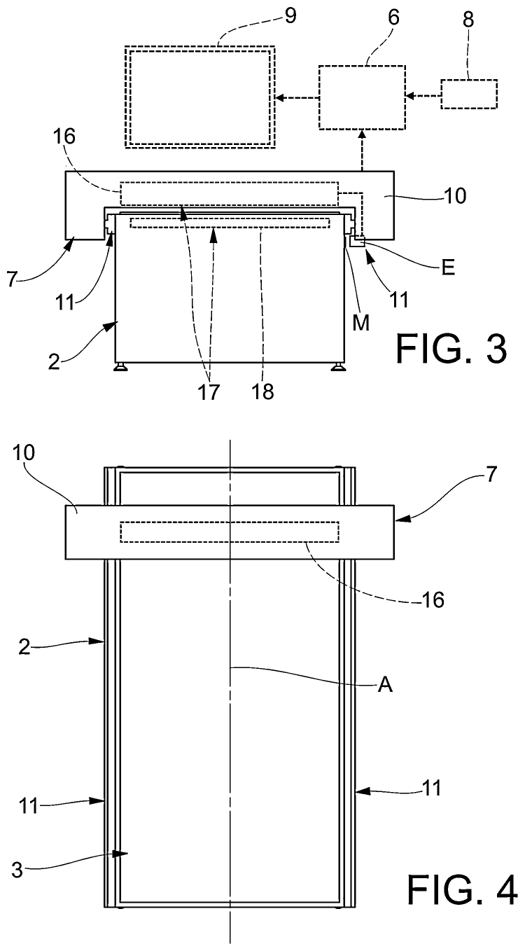

The machine 1 also comprises—and with particular reference to FIG. 3—a control unit 6 (represented schematically); control unit 6 is configured to manage and supervise the operation of machine 1, as better described below.

According to one aspect of the invention, the machine 1 also comprises a scanning unit, generally indicated by 7, of the surface of the at least one printing plate, or offset plate, or plate assembly, or printed surface, 4 to be checked.

The scanning unit 7 is operatively connected to the control unit 6, and it is configured to acquire a real image of the at least one printing plate, or offset plate, or plate assembly, or printed surface, 4 to be checked.

According to another aspect of the invention, the control unit 6 is configured to carry out the comparison between the real image of the at least one printing plate, or offset plate, or plate assembly, or printed surface 4, acquired by the scanning unit 7, and at least one corresponding reference image 8, relating to the creation file of a plate 4 (or to the creation file of a sheet 5 comprising several plates 4), or of an offset plate, or of the plate assembly, or of a printed surface, and the respective creation or printing file.

In more detail, the at least one reference image 8 can be supplied as input to the control unit 6 by the operator responsible for checking the at least one printing plate 4, or offset plate, or plate assembly, or printed surface.

In an embodiment of the invention of particular practical interest, the at least one reference image 8 consists of a graphic file for the creation of a printing plate 4, or of a sheet 5 comprising several plates 4, or, more generally, of a respective file for the creation or printing of the material to be produced.

The machine 1 is also equipped with a user interface 9 (schematically represented in the aforementioned FIG. 3), operationally connected to, and interlocked with, the control unit 6, comprising at least one screen or monitor.

By means of the aforementioned user interface 9, the operator in charge can set and insert the main parameters (for example, dimensional parameters) and instructions to carry out the verification of the characteristics of one or more printing plates 4, or offset plates, or plate assemblies, or printed surfaces, to be verified.

By means of the aforementioned comparison, the control unit 6 allows, automatically, to highlight (preferably, but not exclusively, on a screen of the user interface 9) any discrepancies (or defects D) between the real image I of the at least one printing plate 4, or offset plate, or plate assembly, or printed surface, and the at least one corresponding reference image 8 of the creation file of a printing plate 4, or of the creation file of a sheet 5 comprising several printing plates 4 or the respective creation or printing file of the material to be produced, so as to prevent, upstream of any other operational or production step, any errors or inaccuracies in the execution of the printing.

More specifically, through the aforementioned comparison, the operator is able to find out, very quickly and precisely, whether a certain cliché 4 (or each cliché 4 positioned on the support plane 3), or offset plate, or cliché assembly, or printed surface, is suitable or not to carry out the printing job or jobs for which it was created, or whether it instead presents defects. In other words, the operator, without any discretion of his own, and in an objective manner, is able to easily ascertain whether a certain printing plate 4 (or offset plate, or plate assembly) is affected by manufacturing defects of such a magnitude as to compromise the execution of the printing job, or jobs, for which it was created, or whether the printed surface is not compliant and presents defects.

This saves the time needed to mount unsuitable plates, and avoids the physical production of expensive and laborious proofs, and of course prevents a print job from being started that will not produce the desired results, in the event that a particular plate 4 (or offset plate, or plate assembly) is not suitable for carrying it out.

This also avoids having to ship the defective printing plate 4 (or offset plate, or plate assembly) to the user who requested it.

The comparison between the at least one real image of the at least one printing plate 4, or offset plate, or plate assembly, or printed surface, and the at least one corresponding reference image 8, can be carried out in various ways.

Given that such a comparison could be carried out directly and visually by the operator, the invention nevertheless provides for the use of specific algorithms that allow for the automatic highlighting of the differences between the images, for an immediate comparison of the same, and therefore for an immediate and automatic identification of any manufacturing defects of the printing plate 4, or offset plate, or plate assembly, or printed surface.

According to an aspect of the invention, the user interface 9 is configured to show, superimposed in transparency (or with other more or less similar solutions), the real image I of the at least one printing plate, or offset plate, or plate assembly, or printed surface 4, and the respective reference image 8; as better clarified below, any defects D are shown, or highlighted, by means of closed lines or circles that enclose the affected areas of the screen or with other similar solutions (for example, areas highlighted with different colors).

According to the invention, the machine 1, in its different specially developed versions, can carry out, as mentioned, the verification of one or more printing plates, or offset plates, or plate assemblies, or printed surfaces 4, arranged on the aforementioned support plane 3. In this version of the machine 1, the support plane 3 (and therefore the at least one printing plate 4, or offset plate, or plate assembly, or printed surface, to be checked) is fixed, while the scanning unit 7 moves with respect to it; in other versions of the invention, the scanning unit 7 could instead be kept fixed, while the support plane 3 is movable.

According to one aspect of the invention, the support plane 3 for at least one printing plate, or offset plate, or plate assembly, or printed surface 4 (or for the photopolymer sheet 5, from which several plates 4 will be obtained) comprises at least one plate of transparent, or translucent, material, for reasons that will become clearer later.

For example, the support plane 3 may comprise at least one glass plate, transparent or translucent.

According to another aspect of the invention, the scanning unit 7 comprises a carriage 10, and guide means 11 for the said carriage 10; the guide means 11 are provided in the base 2.

The carriage 10 is movable, in a sliding manner, above the support plane 3, that is, in other words, it can translate with respect to the latter.

In more detail, the carriage 10 is movable, above the support plane 3, along a predetermined direction A.

The base 2 of the machine 1 has a roughly box-like shape; on its upper surface is installed the support plane 3 of the at least one printing plate 4, or offset plate, or plate assembly, or printed surface.

The carriage 10 of the scanning unit 7, on the other hand, is substantially shaped like a portal, and is wider than the base 2.

The guiding means 11 comprise, in more detail, first lateral guides 12, along which the carriage 10 can slide.

The first lateral guides 12 are integral with the lateral sides of the base 2 and, in more detail, extend along the external sides of the upper side members 13 of the base 2; the first lateral guides 12 therefore define the sliding direction A of the carriage 10.

The carriage 10 can translate, along the guide means 11 (and therefore along the first lateral guides 12), manually, or, more preferably, automatically.

In this second case, the scanning unit 7 comprises a drive unit, suitable for carrying out the translational movement of the carriage 10 itself along the guide means 11.

The drive unit, housed inside the carriage 10, may comprise at least one actuator; said actuator may be of any type suitable for carrying out such translational movement. In the embodiment illustrated in the attached figures, the drive unit comprises, more specifically, two rotary actuators, for example two electric motors.

The aforementioned actuators are installed at the two ends 14 of the carriage 10. On the output axes of the above actuators respective toothed wheels (or pinions) are mounted, which engage two respective racks 15, mounted on the base 2 so as to be parallel to the lateral guides 12.

In more detail, as shown in the detail of FIG. 10, the racks 15 are mounted, parallel to the first lateral guides 12, along the external sides of the upper side members 13 of the base 2.

Alternatively, the aforementioned drive unit may comprise a single electric motor, on which a first gear wheel is mounted, which engages a first rack 15, placed on one side of the base 2, and a transmission to transmit the motion to a second gear wheel, supported by the carriage 10, which engages a second rack 15, placed on the other side of the base 2.

According to another aspect of the invention, the scanning unit 7 comprises at least one scanning sensor 16.

In an embodiment of the invention of particular practical interest, and particularly advantageous, the aforementioned scanning sensor 16 comprises at least one linear sensor, or other type of sensor.

The scanning sensor 16 is installed on the carriage 10.

The aforementioned scanning sensor 16, through a relative motion with respect to the at least one printing plate 4, or offset plate, or plate assembly, or printed surface, (in particular through its translational motion with respect to the printing plate 4, or offset plate, or plate assembly, or printed surface, which is instead kept fixed), and therefore through successive steps, provides for the acquisition of the complete real image of the same.

In the specific case in which a linear sensor, or another type of sensor or camera, is used, the latter produces an image consisting of a single line of pixels; the complete image is constructed by a processor (in this case, that of the control unit 6) by exploiting the relative motion between the linear camera itself and the surface of the object (printing plate, or offset plate, or plate assembly, or printed surface 4) of which the image is to be produced.

In this embodiment, the scanning sensor 16 is fixed below the lower surface, in use, of the carriage 10.

In more detail, the scanning sensor 16 is fixed below the lower surface, in use, of the carriage 10 so as to be positioned facing the support plane 3, and at a certain distance (for example, a few millimeters) from the upper surface of the at least one printing plate, or offset plate, or plate assembly, or printed surface 4 to be checked. The scanning sensor 16 may be fixed beneath the lower surface, in use, of the carriage 10 in an adjustable/registrable manner, to allow the scanning unit 7 to adapt to printing plates 4, or offset plates, or plate assemblies, or printed surfaces of different thicknesses (for example, typically the thickness of the plates may vary between 1.14 mm to 5 mm).

The adjustment/registration of the scanning sensor 16 with respect to the carriage 10 can also be carried out manually, or in an automated manner, by means of a specifically designed linear actuator.

Both in the case in which the carriage 10 can be moved along the lateral guides 12 manually, and in the case in which it can be moved automatically, the scanning unit 7 further comprises a sensor E, operationally connected to the scanning sensor 16 and to the control unit 6, which detects the movement of the carriage 10 along the lateral guides 12, thanks to the presence of a reference M along the aforementioned lateral guides 12; the control unit 6, therefore, uses the information provided by the sensor E to construct the real image I of the at least one printing plate, or offset plate, or plate assembly, or printed surface 4, synchronizing the images taken by the scanning sensor 16 with its movement detected, precisely, by the aforementioned sensor E.

According to another aspect of the invention, the scanning unit 7 comprises a lighting device 17 of the reading area of the scanning sensor 16.

In more detail, the lighting device 17 comprises one or more first lighting bodies, positioned in proximity to the scanning sensor 16 (therefore mounted on the carriage 10).

For example, two first lighting bodies may be provided, positioned at the two long sides of the scanning sensor 16 (i.e., upstream and downstream of the scanning sensor 16 with reference to the translation direction A of the carriage 10).

Furthermore, the lighting device comprises at least a second lighting body 18 (represented, schematically, in FIG. 3), and translation means 19 of the aforementioned second lighting body 18 below the support plane 3.

The translation means 19 of the second lighting body 18 are configured to advance the second lighting body 18 together with the carriage 10, at the same speed.

The second lighting body 18 can have a width (intended as the dimension perpendicular to the aforementioned translation direction A) such as to also illuminate the printing plates, or offset plates, or plate assemblies, or printed surfaces 4, of larger dimensions (and therefore it can have a width substantially comparable to that of the support plane 3).

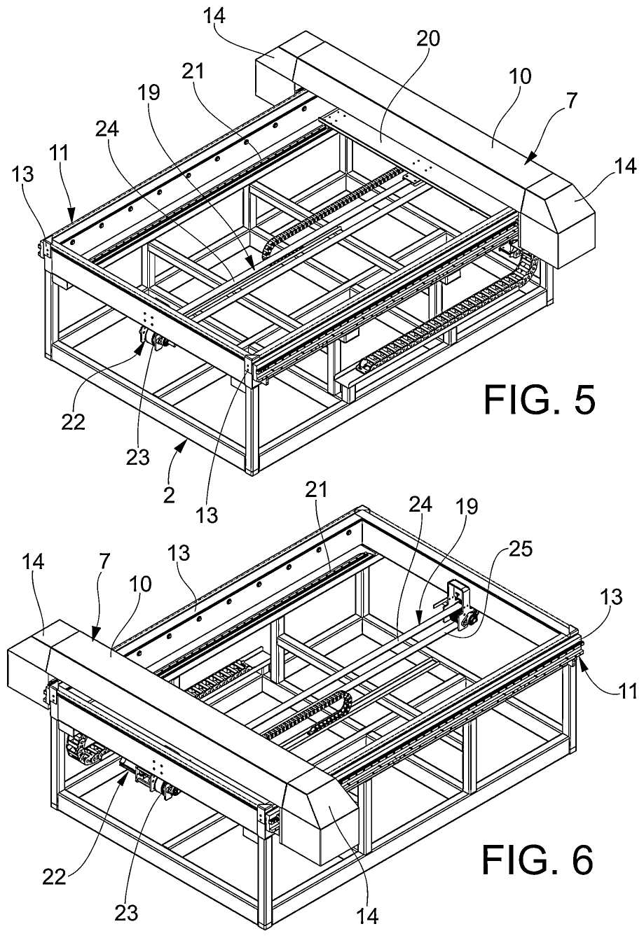

The second lighting body 18 is associated with a respective support 20 (visible, for example, in FIG. 5).

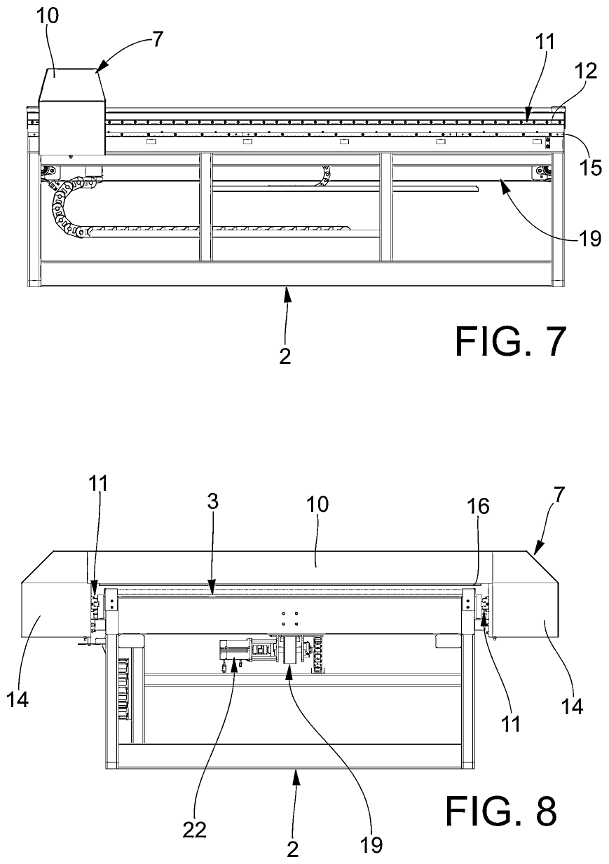

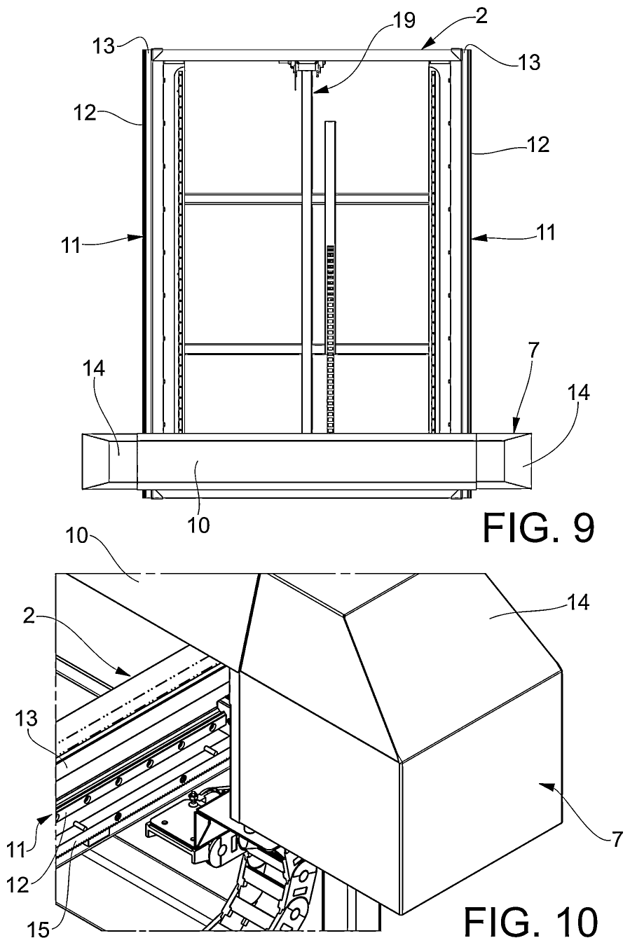

With reference to FIGS. 5-10, which show the machine 1 with some parts of the base 2 removed for greater clarity, the translation means 19 of the second lighting body 18 include second lateral guides 21.

The second lateral guides 21 are fixed to the internal surfaces of the upper side members 13 of the base 2.

The support 20 of the second lighting body 18 comprises, at the respective ends, sliding shoes along the aforementioned second lateral guides 21.

Furthermore, the translation means 19 of the second lighting body 18 can be, for example, of the belt type.

In more detail, in the specific embodiment illustrated in the figures, the translation means 19 of the second lighting body 18 comprise an electric motor 22, on the output axis of which a toothed pulley 23 is mounted.

The electric motor 22 is mounted on the front (or rear, depending on the chosen convention) face of the base 2.

A toothed belt 24, closed in a ring, is wound around the toothed pulley 23 and a further return pulley 25, supported on the rear (or front) face, in use; the support 20 of the second lighting body 18 is, in turn, fixed to the aforementioned toothed belt 24.

Therefore, the operation of the toothed belt 24 determines the advancement of the support 20 of the second lighting body 18 along the second lateral guides 21, and therefore along the predetermined sliding direction A.

Furthermore, other types of locking/constraint means may be provided for the at least one printing plate, or offset plate, or plate assembly, or printed surface 4, on the support plane 3. In an alternative embodiment of the machine 1 according to the invention, the scanning unit 7 is fixed with respect to the base 2, and the support plane 3 is slidable, with respect to the scanning unit 7, along a predetermined direction A.

In another alternative embodiment of the machine 1 according to the invention, the scanning unit 7 is fixed with respect to the base 2, and the at least one printing plate, or offset plate, or plate assembly, or printed surface 4 is movable, with respect to the scanning unit 7, by means of a drive system (for example a conveyor belt, or the like).

The operation of the machine 1 according to the invention is, in light of what has been described, completely intuitive.

Once the at least one printing plate, or offset plate, or plate assembly, or printed surface 4 (or more printing plates, or offset plates, or plate assembly, or printed surfaces 4) to be checked has been positioned (and possibly blocked) on the support plane 3, the machine 1 is started, and then the scanning unit 7, and in particular the carriage 10, starting from one end of the support plane 3 itself, is translated (manually, or, more preferably, automatically), along the first guide means 11, so as to progressively cover the entire surface of the at least one printing plate, or offset plate, or plate assembly, or printed surface 4.

The control unit 6 can thus progressively reconstruct the real image of the at least one printing plate 4 or offset plate, or plate assembly, or printed surface (or of the various printing plates, or offset plates, or plate assemblies, or printed surfaces 4). Once the acquisition is complete, the carriage 10 stops at the other end of the support plane 3, and then returns to the starting position to begin another acquisition cycle.

At the same time as the carriage 10 performs its translation and image acquisition stroke, the second illuminating body 18 is translated simultaneously with the carriage 10, with the same advancement speed, so as to always be in the correct position with respect to the scanning sensor 16 (preferably, underneath it).

In fact, the transparent or translucent support plane 3 allows the passage of light through the plate 5 (or at least one cliché, or offset plate, or cliché assembly, or printed surface 4), which is also made of an essentially transparent or translucent photopolymer, thus facilitating detection by the scanning sensor 16.

In fact, the transparent or translucent support plane 3 allows the passage of light through the sheet 5 (or at least a printing plate, or offset plate, or plate assembly, or printed surface 4), also made of an essentially transparent or translucent photopolymer, thus facilitating its detection by the scanning sensor 16.

Even in the case of offset plates, or plate assemblies, or printed surfaces, the translucent material of the support plane 3 helps and facilitates the reconstruction of the image.

Subsequently, the real image, acquired by the scanning unit 7, of the at least one printing plate, or offset plate, or plate assembly, or printed surface 4 (or even of the entire sheet 5 comprising several plates 4) can be compared with the corresponding reference image 8, previously supplied as input to the control unit 6 (for example in . pdf format), so as to highlight (also with the aid of special algorithms) any differences between the real image of the at least one printing plate, or offset plate, or plate assembly, or printed surface 4, and the aforementioned reference image 8, which could potentially give rise to an incorrect printing job.

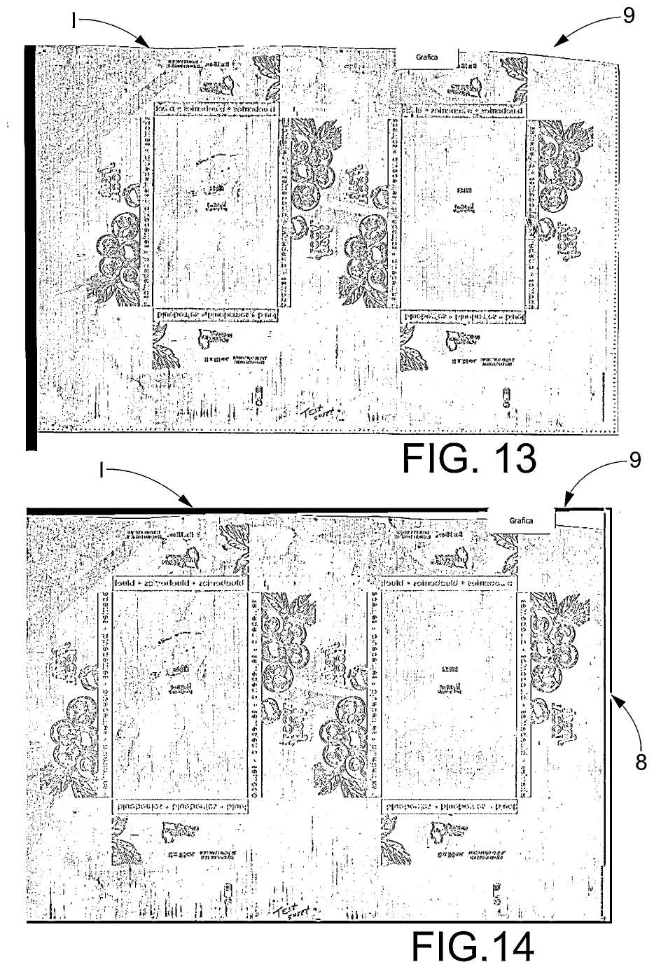

FIGS. 13-20 show, for illustrative but not limiting purposes, some screenshots of the user interface 9 of the machine 1 according to the invention, relating to some examples of verification, carried out by the machine 1 according to the invention, of flexographic plates, or groups of flexographic plates.

In more detail, FIG. 13 is a screenshot of the user interface 9, showing the result of the acquisition of image I of a given flexographic plate, carried out by the scanning unit 7.

FIG. 14 is a screenshot of the user interface 9, showing the comparison between image I of the printing plate in FIG. 13 and the respective reference image 8, superimposed in transparency.

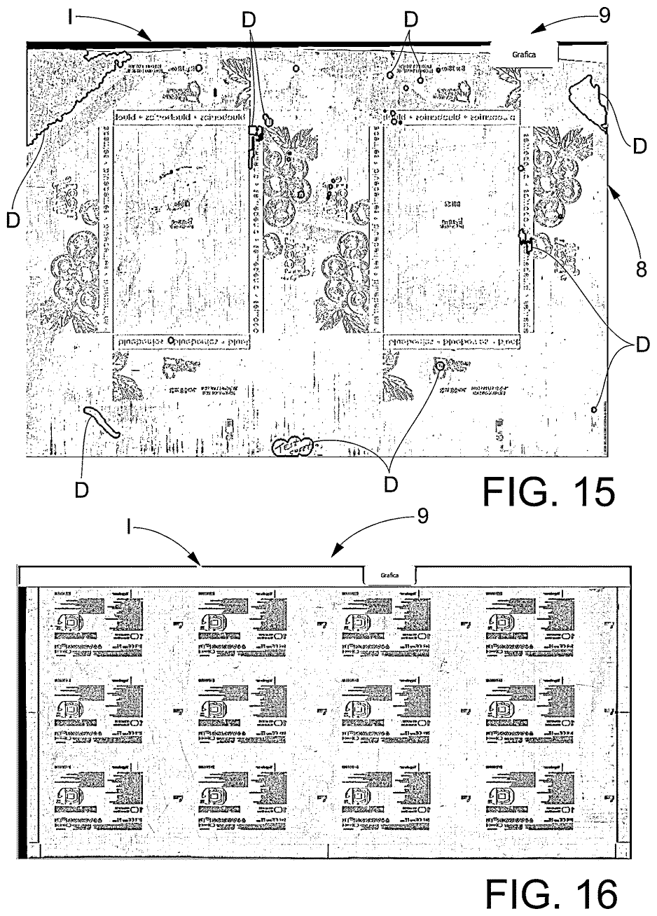

FIG. 15 is a screenshot of the same user interface 9 of the machine, which shows the automatic detection of defects D that emerged from the comparison carried out by the control unit 6.

Defects D are highlighted, for example, by closed lines, or circles or other similar solutions, which enclose the affected areas, in order to draw the operator's attention while validating, automatically or otherwise, the analyzed product.

FIG. 16 is a screenshot of the user interface 9, showing the result of the acquisition of image I of another flexographic plate, performed by the scanning unit 7.

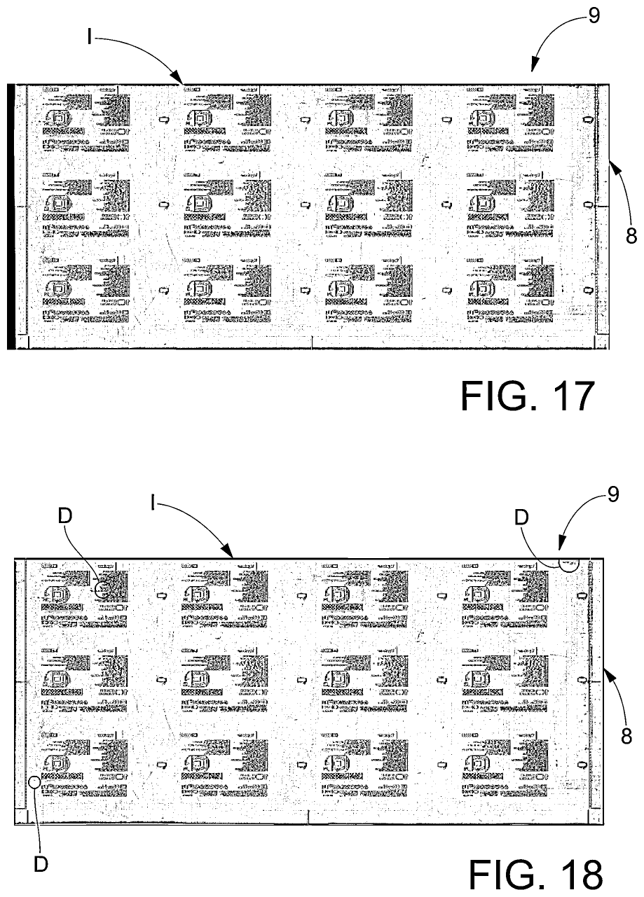

FIG. 17 is a screenshot of the user interface 9, showing the comparison between image I of the printing plate in FIG. 16 and the respective reference image 8, superimposed in transparency.

FIG. 18 is a screenshot of the same user interface 9, showing the automatic detection of defects D that emerged from the comparison carried out by the control unit 6.

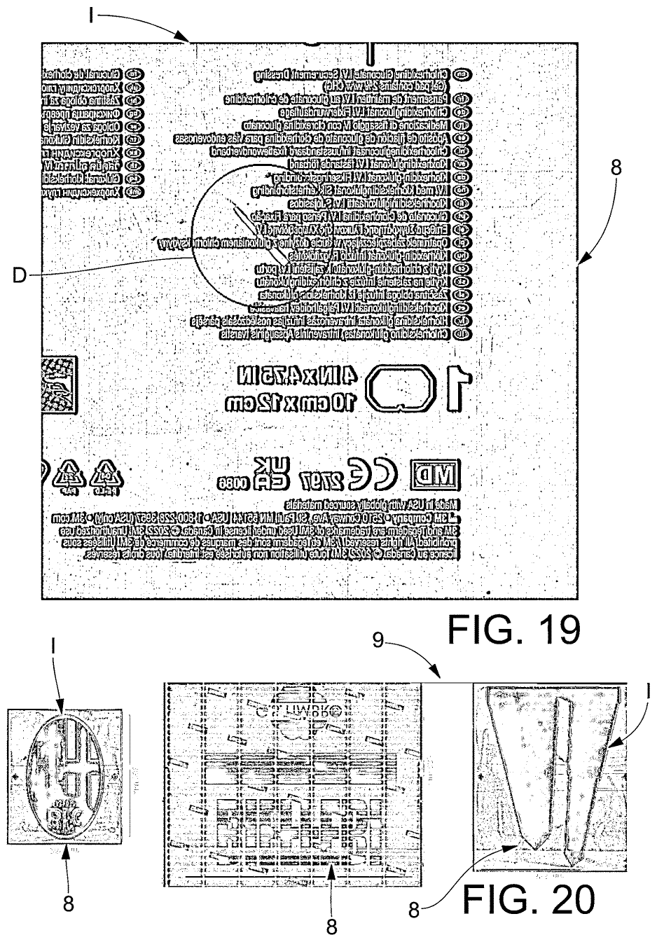

Also in this case, it is noted that the defects D are highlighted by closed lines, or circles, which enclose the affected areas, in order to draw the operator's attention. One of the defects D in FIG. 18 is better visible in the enlargement of FIG. 19.

FIG. 20 is a screenshot of the user interface 9, showing the comparison between image I of a group of flexographic plates and the respective reference images 8,

where it is highlighted that the central plate of the group was mounted by mistake (and therefore does not correspond to the expected one, therefore there is no overlap between the two transparent images).

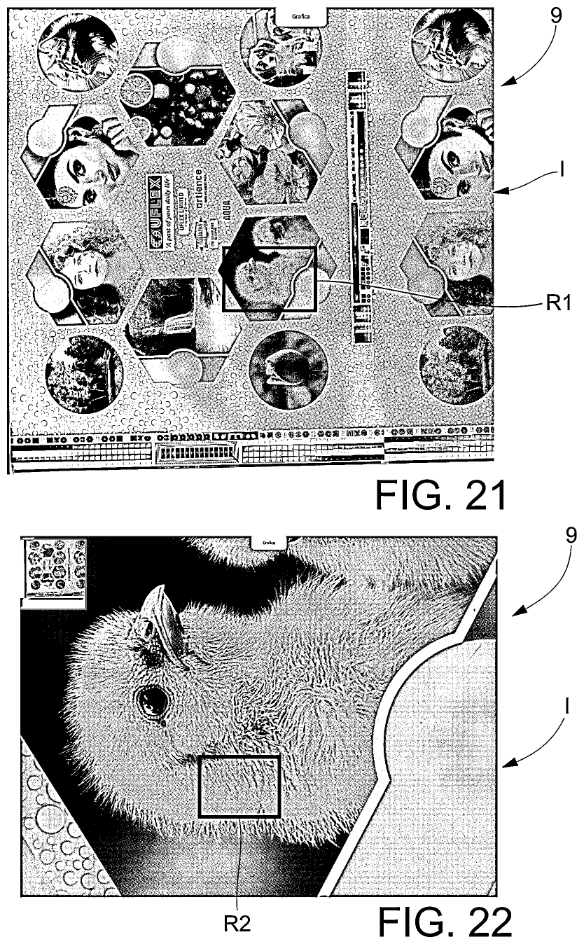

FIG. 21 is a screenshot of the user interface 9, showing the result of the acquisition of the image I of a printed film, performed by the scanning unit 7. FIG. 22 is a screenshot of the machine's user interface 9, which represents a zoom, or enlargement, of the screenshot in FIG. 21, in particular at a first box R1.

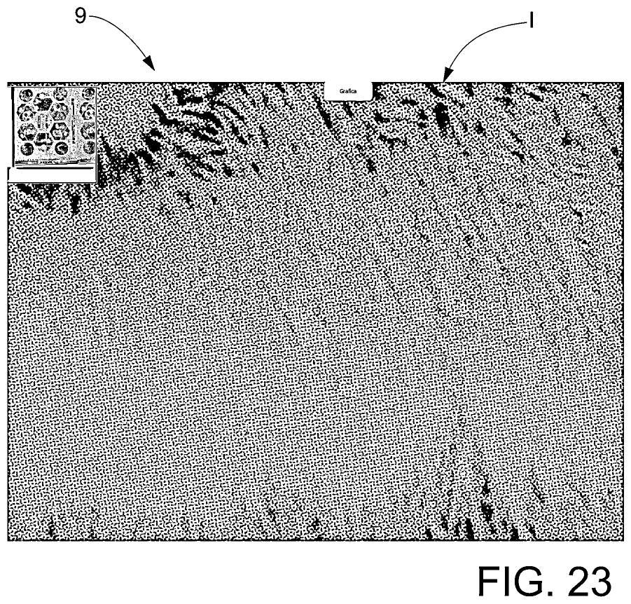

FIG. 23, on the other hand, is a screenshot of the user interface 9, which represents a further zoom, or enlargement, of the screenshot in FIG. 22, in particular at a second box R2.

As can be seen in FIG. 23, machine 1 is able to highlight any defects even down to the printing grid level of a printed surface (for example a printed film, but not only).

As these examples clearly show, therefore, machine 1 is able to highlight, automatically and immediately, the defects D of a printing plate, or offset plate, or plate assembly, or printed surface 4, and in such a way as to allow the operator to evaluate the conformity, or otherwise, of the product.

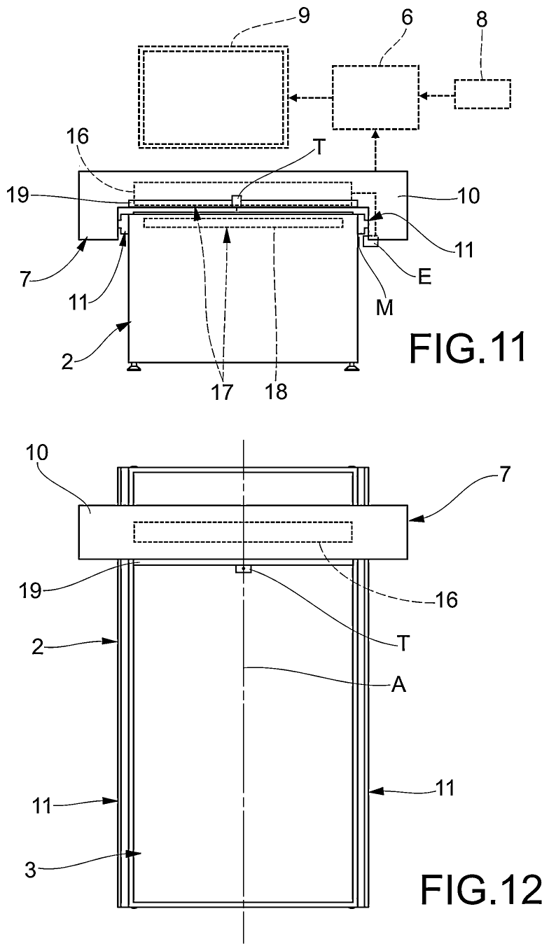

Another embodiment of the machine 1 according to the invention is illustrated in FIGS. 11, 12.

This embodiment of the machine 1 differs from that illustrated in the previous FIGS. 1-10 in that the scanning unit 7 includes at least one touch probe T.

The touch T probe is configured to detect the physical characteristics of the printing plate, or offset plate, or plate assembly, or printed surface 4 to be evaluated, in order to obtain a three-dimensional scan.

The touch probe T is operationally connected to the control unit 6, and thus also to the scanning sensor 16.

Thanks to this, the detections carried out by the touch probe T contribute, together with those of the scanning sensor 16, to reconstruct the real image of the printing plate, or offset plate, or plate assembly, or printed surface 4 to be evaluated, in three dimensions (therefore also considering the thickness of the object being evaluated).

The touch probe T is associated with respective translation means 19, fixed to the carriage 10, which is able to translate the touch probe T in a direction perpendicular to the predetermined direction A; the touch probe T can thus reach all positions on the support plane 3.

The touch probe T is particularly—but not exclusively—useful for detecting the wear of a printing plate, or offset plate, or plate assembly 4 (therefore detecting any discrepancies in thickness compared to the nominal one).

The scan carried out with the aid of the touch probe T can, therefore, determine whether a certain printing plate, or offset plate, or plate assembly 4, used and therefore worn, is, or is not, within the acceptable dimensional tolerances for carrying out a certain job.

We have thus seen how the invention achieves the proposed aims.

The machine is an important tool for the operator in charge of printing, especially flexographic printing and not only, since it allows to automatically and preventively check—and therefore before any other operational or production phase—the quality of the printing plate, or offset plate, or plate assembly, or printed surface, so as to avoid, possibly, assembling of plates that are not compliant in terms of physical or surface characteristics and above all to avoid the creation of relative print tests or, even worse, to start or continue an incorrect printing job.

This result is obtained automatically, very quickly and extremely reliably, thus significantly limiting possible errors due to the human factor.

The manufacturer thus avoids putting into circulation a product affected by manufacturing defects that could compromise the printing work.

This saves significant economic, time and energy resources, reducing the energy consumption of printers.

Considering that false starts in printing are estimated at 4-5% for each printer and that the invention can serve numerous printers, the energy savings and reduction of CO₂ emissions are considerable, considering wasted energy, ink and material.

The proposed construction solution is very simple, economical, and easy and intuitive to use.

The present invention has been described according to preferred embodiments, but equivalent variants can be conceived without departing from the scope of protection offered by the following claims.

1. A machine for checking flexographic printing plates, or offset plates, or plate assemblies, or printed surfaces, comprising:
a base,
a support plane, associated with said base, for at least one printing plate, or offset plate, or plate assembly, or printed surface, the surface or physical characteristics of which are to be checked and controlled,
a control unit,
a surface scanning unit of the at least one printing plate, or offset plate, or plate assembly, or printed surface to be checked,
said scanning unit being operatively connected to said control unit, and configured to acquire a real image of the at least one printing plate, or offset plate, or plate assembly, or printed surface to be checked,
said control unit being configured to automatically compare said real image of the at least one printing plate, or offset plate, or plate assembly, or printed surface, acquired by said scanning unit, and the reference image corresponding to the creation file of a printing plate, or of a sheet of multiple plates, or the creation file of an offset plate or the file of the final print to be made, to automatically recognize any physical or superficial defects in the analyzed object in order to validate it or not to avoid the use of incorrect or worn plates, or to avoid the creation of expensive print tests, or to automatically recognize and avoid an erroneous print or in order to speed up the initialization of new print jobs on existing machines without control systems, reducing in any case, in all these circumstances, energy consumption and therefore CO₂.

2. The machine according to claim 1, wherein said scanning unit comprises a carriage, and guide means, provided in said base, for said carriage, said carriage being slidable, above said support plane, along a predetermined direction, or said scanning unit is fixed with respect to said base, and said support plane is slidable, with respect to said scanning unit, along a predetermined direction, or said scanning unit is fixed with respect to said base, and said at least one printing plate, or offset plate, or plate assembly, or printed surface, is movable with respect to said scanning unit by means of a drag system.

3. The machine according to claim 2, wherein said scanning unit comprises at least one scanning sensor installed on said carriage, said scanning sensor being fixed below the lower surface, in use, of said carriage so as to be positioned facing said support plane, and at a given distance from the upper surface of the at least one printing plate, or offset plate, or plate assembly, or printed surface to be checked.

4. The machine according to claim 3, wherein said scanning sensor comprises at least one linear sensor, or other type of sensor.

5. The machine according to claim 4, wherein said guide means comprise first lateral guides along which said carriage moves, said first lateral guides being integral with the lateral sides of said base, and defining said sliding direction of said carriage.

6. The machine according to claim 5, wherein said scanning unit comprises a drive unit suitable for carrying out the translation of said carriage along said guide means, said drive unit comprising two rotary actuators, installed at the two ends of said carriage, on whose output axes are mounted respective toothed wheels which engage two respective racks, mounted, on said base, parallel to said lateral guides.

7. The machine according to claim 1, wherein said support plane for at least one printing plate, or offset plate, or plate assembly, or printed surface, comprises at least one sheet of transparent or translucent material.

8. The machine according to claim 7, wherein said scanning unit comprises at least one lighting device of the reading area of said scanning sensor.

9. The machine according to claim 8, wherein said lighting device comprises at least one lighting body and means for moving said lighting body underneath said support plane, said translation means being configured to move said lighting body forward together with said carriage, at the same speed.

10. The machine according to claim 5, wherein said scanning unit comprises a sensor, operatively connected to said scanning sensor and to said control unit, configured to detect the movement of said carriage along said lateral guides, thanks to the presence of a reference along said lateral guides, said control unit being then configured to use the information provided by said sensor to construct the real image of the at least one printing plate, or offset plate, or plate assembly, or printed surface, by synchronizing the images taken by said scanning sensor with its movement detected by said sensor.

11. The machine according to claim 3, wherein said scanning unit comprises at least one touch probe, operatively connected to said control unit, configured to detect the physical characteristics of the printing plate, or offset plate, or plate assembly, or printed surface to be evaluated, so as to obtain a three-dimensional scan thereof.

12. The machine according to claim 11, wherein said touch probe is associated with respective translation means, fixed to said carriage, capable of translating said touch probe in a direction perpendicular to said predetermined direction, so that said touch probe can reach all positions on said support plane.

13. The machine according to claim 1, comprising a user interface operationally connected to, and interlocked with, said control unit, comprising at least one screen or monitor, said user interface being configured to show, superimposed in transparency, or with similar solutions, the real image of the at least one printing plate, or offset plate, or plate assembly, or printed surface, and the respective reference image, in which any differences or defects are automatically shown and highlighted by closed lines, or circles, which enclose the areas of the screen concerned or with other similar solutions, in order to validate the product or not.
